(19) United States
(12) Patent Application Publication
(10) Pub. No.: US 2021/0053534 A1
(43) Pub. Date: Feb. 25, 2021

(54) RV CLEANING DEVICE

(71) Applicants: Eric Schwebach, Alton, IA (US); Stephanie Schwebach, Alton, IA (US)

(72) Inventors: Eric Schwebach, Alton, IA (US); Stephanie Schwebach, Alton, IA (US)

(21) Appl. No.: 16/547,404

(22) Filed: Aug. 21, 2019

(51) Int. Cl. B60S 3/04; A46B 5/00

(52) U.S. Cl. CPC B60S 3/045; B60P 3/32; A46B 5/0095

(57) ABSTRACT

An illustrated view of an exemplary RV cleaning device for cleaning an exterior of a recreational vehicle (RV) is presented. The RV cleaning device is useful for removing unwanted material from a top of RV slide outs, such as dirt, leaves, water and snow. The RV cleaning device has a handle which is extendable, a pole coupled to the handle, and a interchangeable head that can be used to clean the dirt, leaves, limbs, snow and water from the top of a slide of an RV easily and efficiently and not jeopardizing the safety of a user.

### FIELD OF THE INVENTION

This invention relates to Recreational Vehicles (RVs). More particularly, it relates to cleaning devices for RVs.

### BACKGROUND

A recreational vehicle, often abbreviated as RV, is a motor vehicle or trailer which includes living quarters designed for accommodation. Types of RVs include motorhomes, campervans, caravans (also known as travel trailers and camper trailers), fifth-wheel trailers, popup campers and truck campers.

Typical amenities of an RV include a kitchen, a bathroom, and one or more sleeping facilities. RVs can range from the utilitarian—containing only sleeping quarters and basic cooking facilities—to the luxurious, with features like air conditioning (AC), water heaters, televisions and satellite receptors, and quartz countertops, for example.

RVs can either be trailers (which are towed behind motor vehicles) or self-motorized. Most RVs are single-deck; however, double-deck RVs also exist. To allow a more compact size while in transit, larger RVs often have expandable sides, called slide-outs, or canopies.

RVs are large and when they become dirty while sitting in a camp ground, driveway, storage area, etc. cleaning an RV is difficult and time consuming. Many times, washing the RV or scrubbing an RV requires a ladder and a hose. Often times, those items can become hazards or hard to get to all reaches of the RV.

In light of the above, there is a need to have a device which can reach all aspects of an RV without having to climb a ladder or other device to clean the RV of dirt, leaves, sticks and the like.

### BRIEF DESCRIPTION OF THE DRAWINGS

FIG. 1 an illustrated view of an exemplary RV cleaning device.

FIG. 2 is an illustrated completed view of the RV cleaning device shown in FIG. 1.

FIG. 3 is an illustrated view of a use of the RV cleaning device shown in FIG. 2.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

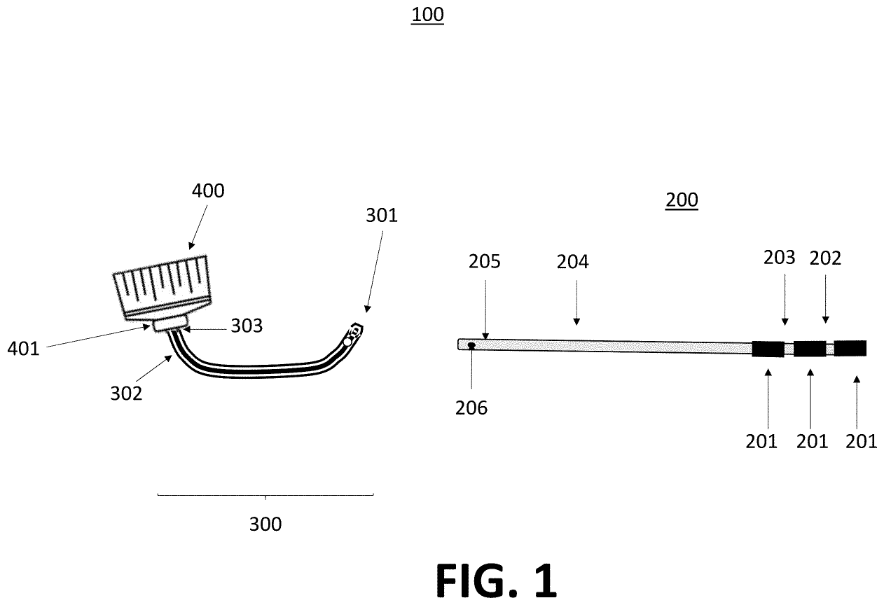

Referring to FIG. 1, an illustrated view of an exemplary RV cleaning device 100 for cleaning an exterior of a recreational vehicle (RV) is presented. The RV cleaning device 100 is useful removing unwanted material from a top of RV slide outs, such as dirt leaves, water and snow.

The RV cleaning device 100 has a handle 200, a pole 300 and a head 400. The handle 200 is preferably made of an aluminum material, but other materials are hereby contemplated, including, but not limited to, plastic, high-density poly-ethylene (HDPE), poly-vinyl chloride (PVC), etc. The handle 200 is preferably adjustable but may be static in length.

The handle 200 is preferably made of an aluminum material, but other materials are hereby contemplated, including, but not limited to, plastic, high-density poly-ethylene (HDPE), poly-vinyl chloride (PVC), etc. The handle 200 is preferably straight but may alternatively angled. When the handle 200 angled, the angle of the handle 200 is preferably 45° but other angles are hereby contemplated, including, but not limited to, 30°, 60°, etc.

The handle 200 has one or more extension couplings 201. The extension couplings are preferably a pressure coupling, but other types of couplings are hereby contemplated, including, but not limited to, a screw coupling, a button release coupling, etc. The handle 200 is extendable in length.

The handle 200 has one or more handle sections 202, 203, 204. The one or more handle sections 202, 203, 204 are extended utilizing the one or more extension coupling 201. After extending the handle 200 to a desired or predetermined length, the one or more extension couplings 201 are tightened such that the handle sections 202, 203, 204 are securely lengthened to the desired or predetermined length. At the first end 205 of the handle 200 is a first coupling connection 206. The first coupling connection 206 is preferably a quick release coupling, but other types of couplings are hereby contemplated, including, but not limited to, screw couplings, pressure couplings, etc.

The pole 300 has a first end 301 and a second end 302. The first end 301 of the pole 300 is securely coupled to the first end 205 of the handle 200 by the coupling connection coupling 206. The pole 300 is preferably a u-shape, but other shapes are hereby contemplated, including, but not limited to, straight shape, angled shape, etc. The pole 300 preferably is angled to be 90°, but other angles are hereby contemplated, including, but not limited to, 60°, 75°, etc. The pole 300 is preferably made of an aluminum material, but other materials are hereby contemplated, including, but not limited to, plastic, high-density poly-ethylene (HDPE), poly-vinyl chloride (PVC), etc.

The head 400 is preferably removable. The head 400 is preferably a brush head, but other types of heads are hereby contemplated, including, but not limited to, squeegee head, snow scraper head, broom head, a mop head, etc. The head 400 has a first end 401. The first end 401 of the head 400 is removably coupled to the second end 302 of the pole 300 by a second coupling connection 303. The second coupling connection 303 is preferably a quick release coupling, but other types of couplings are hereby contemplated, including, but not limited to, screw couplings, pressure couplings, etc.

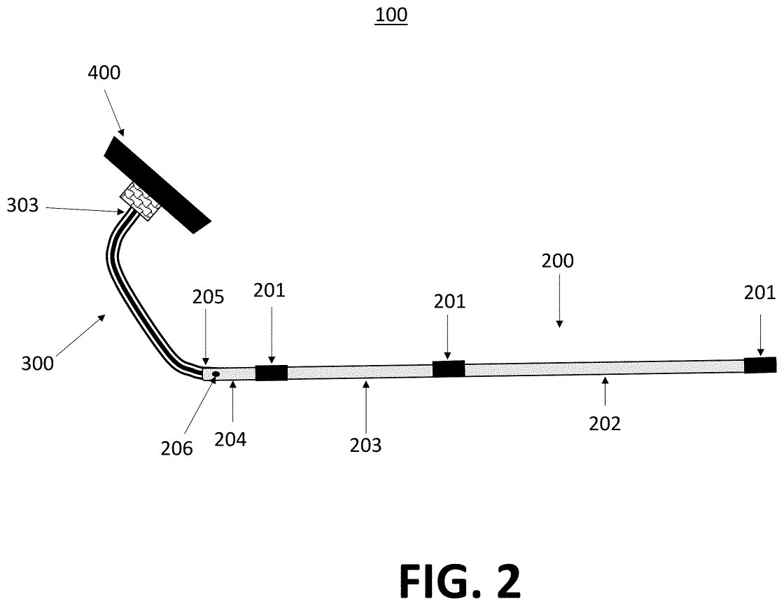

Moving now to FIG. 2, the RV cleaning device shown in FIG. 1 is shown in assembled is presented.

The handle 200 is extended such that each of the handle sections 202, 203, 204 have been extended to a desired length. The extension couplings 201 are tightened such that the handle sections 202, 203, 204 are securely coupled to each other to avoid any of the handle sections 202, 203, 204 from extending or retracting from the desired length.

The pole 300 is securely and removably coupled to the handle 200 by the connection coupling 206. The head 400 is securely and removably coupled to the pole 300 by the second coupling connection 303. The head 400 being a squeegee head.

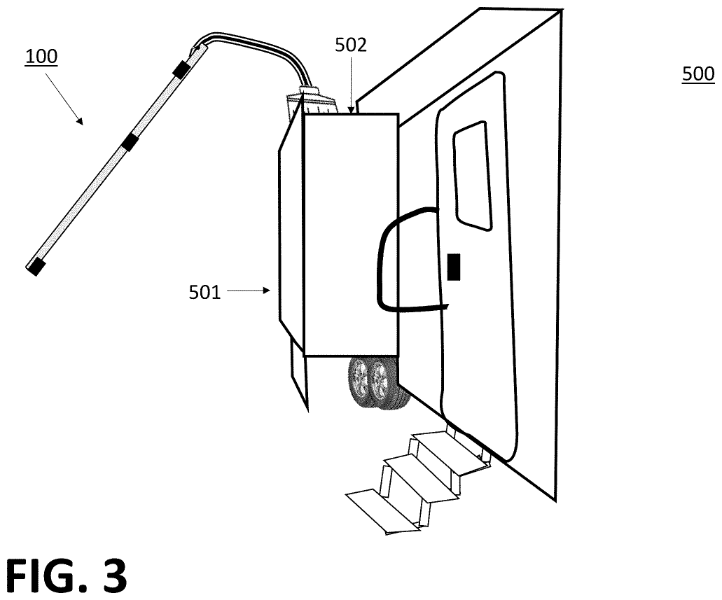

FIG. 3 illustrates the use of the RV cleaning device 100 cleaning the 502 of a slide 501 of a RV 500. The handle 200 is held securely in a hand of a person cleaning the RV 500. The RV cleaning device 100 is lifted to a desired location at the top 502 of the slide 501 of the RV 500. Thus, while standing on the ground in a safe location, the top 502 of the slide 501 of the RV 500 can have any debris, such as leaves, dirt, limbs, rocks, water and/or snow removed efficiently, effectively without jeopardizing the safety of the person cleaning the RV 500.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A Recreational Vehicle (RV) cleaning device for cleaning a top of a slide of the RV, the device consisting of:
a handle, the handle having one or more handle sections;
a pole, the pole removably coupled to the handle by a first coupling connection, wherein the first coupling connection being a quick release coupling; and
a head, the head being removably coupled to the pole by a second coupling connection, wherein the second coupling connection being a quick release coupling, and wherein the head for cleaning the top of the slide of the RV.

2. The device of claim 1, wherein the handle being made of an aluminum material.

3. The device of claim 1, wherein the pole being made of an aluminum material.

4. (canceled)

5. The device of claim 1, wherein the pole being a U-shape.

6. (canceled)

7. (canceled)

8. The device of claim 1, wherein the handle being extendable.

9. The device of claim 1, wherein the handle being retractable.

10. The device of claim 1, wherein the one or more handle sections being coupled to another of the one or more handle sections by an extension coupling.

11. The device of claim 10, wherein the extension coupling being a pressure coupling.

12. The device of claim 1, wherein the head being removable.

13. The device of claim 1, wherein the pole being removable.

14. The device of claim 1, wherein the head being a broom head.

15. The device of claim 1, wherein the head being a squeegee head.

16. A Recreational Vehicle (RV) cleaning device for cleaning a top of a slide of the RV, the device consisting of:
a handle, the handle having one or more handle sections, wherein the one or more handle sections being coupled to another of the one or more handle sections by an extension coupling, wherein the handle being made of an aluminum material, and wherein the extension coupling being a pressure coupling;
a pole, the pole removably coupled to the handle by a first coupling connection, wherein the first coupling connection being a quick release coupling, wherein the pole being removable, wherein the handle being retractable and extendable, wherein the pole being a U-shape, and wherein the pole being made of an aluminum material; and
a head, the head being removably coupled to the pole by a second coupling connection, wherein the second coupling connection being a quick release coupling, wherein the head is removable, wherein the head is a broom head, and wherein the head for cleaning the top of the slide of the RV.
